(19) United States
(12) Patent Application Publication
(10) Pub. No.: US 2015/0156425 A1
(43) Pub. Date: Jun. 4, 2015

(54) SHOOTING SYSTEM AND METHOD

(71) Applicants: INVENTEC (PUDONG) TECHNOLOGY CORPORATION, Shanghai (CN); INVENTEC CORPORATION, Taipei (TW)

(72) Inventor: Sean LIU, Shanghai (CN)

(73) Assignees: INVENTEC (PUDONG) TECHNOLOGY CORPORATION, Shanghai (CN); INVENTEC CORPORATION, Taipei (TW)

(21) Appl. No.: 14/275,958

(22) Filed: May 13, 2014

(30) Foreign Application Priority Data
Nov. 29, 2013 (CN) 201310628674.1

(51) Int. Cl. H04N 5/262; G10L 15/26; H04N 5/232

(52) U.S. Cl. CPC H04N 5/2621; H04N 5/23216; H04N 5/23245; H04N 5/23293; G10L 15/26

(57) ABSTRACT

A shooting system and method are disclosed, in which a first picture and a second picture are directly composed into a composite photograph when a smart wearable device selects the first picture and then takes the second picture, and the composite photograph is displayed by the smart wearable device, whereby achieving in the technical efficacy of convenient photograph compositing on the smart wearable device.

### BACKGROUND OF THE RELATED ART

1. Technical Field

The present invention relates to a shooting system and method, and particularly to a shooting system and method in which a photograph compositing function is undertaken.

2. Related Art

With development of various electronic products, they are equipped with various kinds of functions, including the shooting function. Presently, a smart wearable device has a rapid development.

For the currently available shooting devices, they are too heavy and thus not so convenient to be carrier at hand. When a user desires to take pictures, he/she needs to take out the shooting device and clicks the key of the shooting device. However, the mart wearable deice is light in weight, wearable, and convenient to be carried at hand. The shooting function on the smart wearable device may let the user shoot pictures so easily, fast and convenient.

However, most of the presently smart wearable devices do not provide the function of photograph compositing, or only use the photograph compositing function after some complex operations.

In view of the above, it may be known that the prior art smart wearable device usually has the issue of photograph compositing, and thus there is quite a need to set forth an improvement means to settle down this problem.

### SUMMARY

In view of the issue of photograph compositing encountered in the prior art, the present invention discloses a shooting system and method, applied onto a smart wearable device.

According to the present invention, the shooting system for a smart wearable device, comprises an shooting module, taking a first picture and taking a second picture when the smart wearable device is in a photograph compositing mode; a photograph compositing module, composing the first picture and the second picture into a composite photograph; and a displaying module, displaying the first picture on a displaying area of the smart wearable device, and displaying the composite photograph on the displaying area when the smart wearable device is in the photograph compositing mode.

According to the present invention, the shooting method, applied onto a smart wearable device, comprises steps of taking a first picture and displaying the first picture on a displaying area of the smart wearable device; entering a photograph compositing mode by the smart wearable device; taking a second picture; and displaying a composite photograph on the displaying area after taking the second picture, the composite photograph comprises the first picture and the second picture.

The system and method of the present invention has the difference as compared to the prior art that the first picture and the second picture are directly composed into the composite photograph when the smart wearable device selects the first picture and then takes the second picture, and the composite photograph is displayed by the smart wearable device, whereby solving the issue encountered in the prior art and it is so convenient to use photograph compositing on the smart wearable device.

### BRIEF DESCRIPTION OF THE DRAWINGS

The present invention will be apparent from the following detailed description, which proceeds with reference to the accompanying drawings, wherein the same references relate to the same elements.

FIG 1 is a systematic architecture diagram of a shooting system according to the present invention.

FIG 2 is a flowchart of a shooting method according to the present invention.

### DETAILED DESCRIPTION

The present invention will be apparent from the following detailed description, which proceeds with reference to the accompanying drawings, wherein the same references relate to the same elements. With reference to the detailed description, those skilled in the art may use the technical skill to solve the associated problem and thus achieve in the technical efficacy associated therewith, namely, may be enabled to implement the present invention.

The present invention is applied onto a smart wearable device, and use photograph compositing when a picture is immediately taken by the smart wearable device. The smart wearable device may be a smart device which may be worn by a user, such as smart glasses. However, this is only an example, without limiting the present invention.

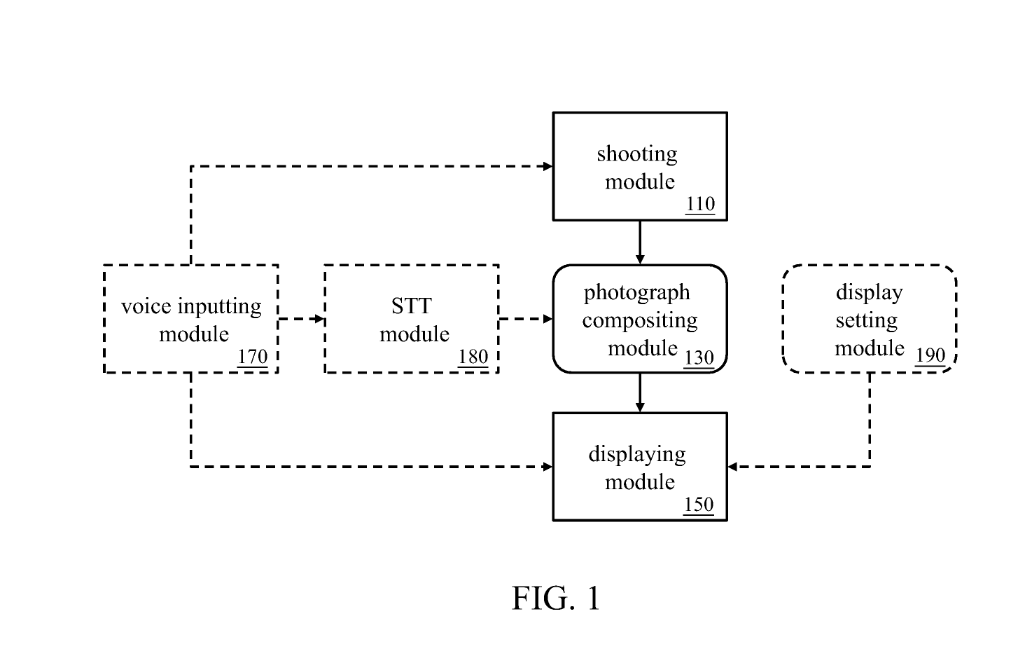

In the following, how a system of the present invention is operated will be described with reference to FIG. 1, in which a systematic architecture diagram of a shooting system according to the present invention is shown. The system of the present invention comprises a shooting module 110, a photograph compositing module 130, and a displaying module 150.

The shooting module 110 is used to take pictures. In this invention, when the smart wearable device is in a photograph compositing mode, the shooting module 110 take a picture, this picture is termed as “second picture”; when the smart wearable device is not in the photograph compositing mode, the picture taken by the shooting module 110 is termed as “first picture”.

The photograph compositing module 130 is used to compose the first and second pictures taken by the shooting module 110, after the smart wearable device enters the photograph compositing mode to take the second picture. The thus generated image after the composition process is termed as “composite photograph” in this invention, the composite photograph comprises the first picture and the second picture.

The displaying module 150 displays the first and second picture taken by the shooting module 110 on the displaying area of the smart wearable device, and also displays the composite photograph generated by the photograph compositing module 130 on the displaying area.

In some embodiments, the displaying module 150 displays the first picture taken by the shooting module 110 at a particular displaying position on the displaying area of the smart wearable device. When the smart wearable device is in the photograph compositing mode, the shooting module 110 may directly take another picture within a visible range of the user, and such picture is usually displayed on the whole displaying area by the displaying module 150.

In addition, the present invention may also comprises a voice inputting module 170, a STT (sound to text) module 180 and a display setting module 190, which may be additionally introduced to the system of the present invention.

The voice inputting module 170 may provide an input of a voice when the smart wearable device is in the photograph compositing mode and before the second picture is taken by the shooting module 110. Generally, the voice inputting module 170 determining whether the inputted voice is a voice command or not. If the voice is a voice command, the voice inputting module 170 provides the voice command to the shooting module 110, in which the voice command may control the shooting module 110 to take the second picture.

In some embodiments, the voice inputting module 170 stores sample waveform of each of voice commands. The voice inputting module 170 can compares the sample waveforms and the inputted voice, and determines the inputted voice is a voice command when the inputted voice matches any one of the sample waveforms. If the inputted voice does not match any of the sample waveforms, the inputted voice is not a voice command. However, this is only examples, without limiting voice inputting module 170 determines whether the inputted voice is a voice command or not.

When the smart wearable device is in the photograph compositing mode, the STT module 180 may convert the voice inputted by the voice inputting module 170 into a text if the inputted voice is not a voice command, and the photograph compositing module 130 may compose the text into the composite photograph, or the photograph compositing module 130 compose the text into the first picture.

The display setting module 190 is used to set displaying parameters of the first and second pictures, such as displaying position and displaying size of the first and second pictures with respect to the display area. For example, the displaying setting module can set a displaying proportion of the first picture on the displaying area, and set the displaying position of the first and second pictures on the displaying area, respectively. However, these are only examples, without limiting the present invention.

In some embodiments, the voice command inputted through the voice inputting module 170 may further be used to control the display setting module 190, the displaying setting module 190 changes the displaying parameters of the first and second pictures on the displaying area according to the voice command, such as setting the displaying size of the first picture as displayed, and the displaying position of the first and second pictures on the displaying area.

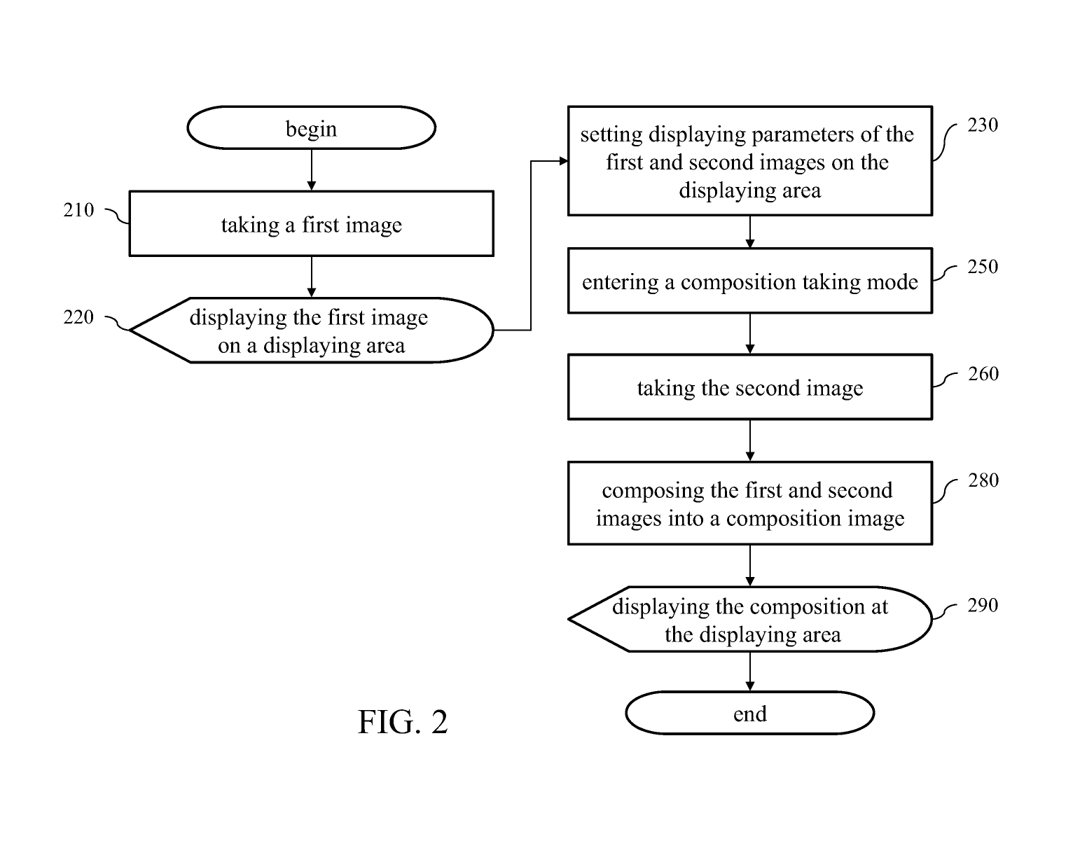

Thereafter, an embodiment is set forth to explain how the system and method of the present invention are operated, with reference to FIG. 2, in which a flowchart of a shooting method according to the present invention is shown. In this embodiment, assume the smart wearable device is smart glasses, but which is only an example without limiting the present invention.

At first, the user may operate the smart wearable device into a general shooting mode, so that the shooting module 110 may take the first picture (S210), and the displaying module 150 may display the first picture taken by the shooting module 110 (S220) on the displaying area based on one or more displaying parameters.

If the user expects to composite photograph at the time of the shooting process is performed, the user may operate and enable the smart wearable device to enter the photograph compositing mode (S250). In this embodiment, assume the user controls the smart wearable device to enter the photograph compositing mode by using a virtual touch technology provided by the smart wearable device itself, such as touch a corresponding virtual control button displayed on the displaying area. However, this is only an example, without limiting the present invention. For example, the user may also control the smart wearable device to enter the photograph compositing mode through a mode switching voice command inputted from the voice inputting module 170.

After the smart wearable device enters the photograph compositing mode (S250), the smart wearable device may prompt the user to select a picture to be composed, i.e. the user may operate the smart wearable device to select a picture to be composed from multiple pictures (first picture) taken previously.

Similarly, when the smart wearable device is in the photograph compositing mode (S250), the user may operate the smart wearable device to enable the shooting module 110 take the second picture (S260). In this embodiment, the user similarly inputs a shooting command through the virtual touch technology provided by the smart wearable device, such as touch another corresponding virtual control button displayed on the displaying area, or inputs a voice command for taking the second picture by the voice inputting module 170, so that the shooting module 110 takes the second picture.

In real implementation, the step where the shooting module 110 takes the second picture (S260) and the step where the user selects the first picture by using the smart wearable device have no limitation in their appearing order.

After the shooting module 110 takes the second picture (S260) and the user selects the first picture via using the smart wearable device, the photograph compositing module 130 may compose the first and second pictures to generate a composite photograph (S280), in which the composite photograph comprises the first and second pictures. And, the displaying module 150 may display the composite photograph generated and composed by the photograph compositing module 130 (S290).

As such, the user may finish the photograph compositing process at the same time of the user takes the second picture.

In the above embodiment, if the smart wearable device comprises the voice inputting module 170 and the STT module 180, the user may input a voice through the voice inputting module 170 and then the STT module 180 may convert the voice inputted by the user into a text before the shooting module 110 takes the second picture (S260). As such, when the photograph compositing module 130 generates the composite photograph (S280), the generated composite photograph also composes the text generated by the STT module 180. In this embodiment, the photograph compositing module 130 adds the text into the composite photograph, wherein the text is an explanation or note of the composite photograph.

In addition, in the above embodiment, after the user selects the first picture to be composed, the displaying module 150 may display the first picture selected by the user on the displaying area of the smart wearable device based on displaying parameters of the first picture, such as displaying position, displaying size, displaying proportion, or any combination of the above items. And after the shooting module 110 takes the second picture, the displaying module 150 may also display the second picture on the displaying area based on displaying parameters of the second picture. If the smart wearable device comprises the display setting module 190, the user may preset the displaying parameters such as setting the displaying position and the displaying size of the first and second pictures, respectively (S230) for adjusting the displaying position and the displaying size of the first and second pictures being displayed on the displaying area, before or after the displaying module 150 displays the first picture.

In summary, it may be known that the system and method of the present invention has the difference as compared to the prior art that the first picture and the second picture are directly composed into the composite photograph when the smart wearable device is in the photograph compositing mode, selects the first picture and then takes the second picture, and the composite photograph is displayed by the smart wearable device, whereby solving the issue encountered in the prior art where the photograph compositing difficultly conduct on the smart wearable device and making photograph compositing more convenient on the smart wearable device.

Furthermore, the method for executing a target function according to the present invention may be implemented in hardware, software or a combination thereof. Alternatively, the method may also be implemented in a single unit or separate computer systems connected with one another with discrete components arranged therein.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A shooting method, applied onto a smart wearable device, the method comprising steps of:
taking a first picture by the smart wearable device and displaying the first picture on a displaying area of the smart wearable device;
entering a photograph compositing mode by the smart wearable device;
taking a second picture by the smart wearable device; and
displaying a composite photograph on the displaying area after taking the second picture, the composite photograph comprises the first picture and the second picture.

2. The shooting method as claimed in claim 1, wherein the step of taking the second picture by the smart wearable device further comprises a step of:
inputting a voice command into the smart wearable device, by which the step of taking the second picture is performed.

3. The shooting method as claimed in claim 1, wherein further comprises a step of inputting a voice into the smart wearable device and converting the voice into a text by the smart wearable device before the step of taking the second picture.

4. The shooting method as claimed in claim 3, wherein the composite photograph further comprises the first picture, the second picture, and the text.

5. The shooting method as claimed in claim 1, further comprises a step of setting the displaying positions of the first and second pictures, before or after the step of displaying the first picture on the displaying area of the smart wearable device.

6. A shooting system for a smart wearable device, the system comprising:
a shooting module, taking a first picture by the smart wearable device, and taking a second picture when the smart wearable device is in a photograph compositing mode;
a photograph compositing module, composing the first picture and the second picture into a composite photograph; and
a displaying module, displaying the first picture on a displaying area of the smart wearable device, and displaying the composite photograph on the displaying area.

7. The shooting system as claimed in claim 6, wherein the system further comprises a voice inputting module for providing an input of a voice command to control the shooting module to take the second picture.

8. The shooting system as claimed in claim 6, further comprises a STT (Sound to Text) module for converting an inputted voice into a text.

9. The shooting system as claimed in claim 8, wherein the photograph compositing module further composes the text into the composite photograph.

10. The shooting system as claimed in claim 6, wherein the system further comprises a display setting module for the displaying positions of the first and second pictures.
